(19) United States
(12) Patent Application Publication
(10) Pub. No.: US 2024/0322539 A1
(43) Pub. Date: Sep. 26, 2024

(54) HOUSING BOX

(71) Applicant: YAZAKI CORPORATION, Tokyo (JP)

(72) Inventors: Ayumu Kurizono, Makinohara-shi (JP); Tsukasa Saito, Makinohara-shi (JP); Toshihisa Yagi, Tokyo (JP); Genki Murakoshi, Tokyo (JP)

(21) Appl. No.: 18/592,443

(22) Filed: Feb. 29, 2024

(30) Foreign Application Priority Data
Mar. 23, 2023 (JP) 2023-046150

(51) Int. Cl. H02G 3/08; B60R 16/023

(52) U.S. Cl. CPC H02G 3/088; B60R 16/0238; H02G 3/081

(57) ABSTRACT

A housing box includes: a main body portion; and an upper cover, in which the main body portion has an inner wall and an outer wall, and has a drain portion, the upper cover has an inner wall, a middle wall, and an outer wall, and has a housing space formed at a base end portion between the middle wall and the inner wall, and a labyrinth structure in which the inner wall is inserted between the inner wall and the middle wall and the outer wall is inserted between the middle wall and the outer wall is formed to block water ingress between the main body portion and the upper cover by the labyrinth structure.

### CROSS-REFERENCE TO RELATED APPLICATION(S)

The present application claims priority to and incorporates by reference the entire contents of Japanese Patent Application No. 2023-046150 filed in Japan on Mar. 23, 2023.

### BACKGROUND OF THE INVENTION

### 1. Field of the Invention

The present invention relates to a housing box.

### 2. Description of the Related Art

Hitherto, for example, a housing box including a lid body openable and closable with respect to a casing as described in Japanese Patent Application Laid-open No. 2001-072116 A is known as the housing box. In the housing box, a packing is disposed at a position where the lid body abuts on the casing to block water ingress between the housing and the lid body.

Incidentally, a required water ingress blocking performance of this type of housing box may vary depending on an installation place, an environment, or the like. In this case, it is conceivable to change a design of a structure of the housing box according to the required water ingress blocking performance, but the manufacturing cost increases. Therefore, it is desired to develop a housing box whose water ingress blocking performance is adjustable as necessary.

### SUMMARY OF THE INVENTION

Therefore, an object of the present invention is to provide a housing box whose water ingress blocking performance is adjustable.

In order to achieve the above mentioned object, a housing box according to one aspect of the present invention includes a main body portion that is configured to house an object to be housed in the main body portion and has an opening portion formed to communicate between an inside and an outside of the main body portion; and a cover portion that is attached to the main body portion in such a way as to cover the opening portion, wherein the main body portion has a main body portion side inner wall and a main body portion side outer wall formed in an attachment direction of the cover portion at an end portion to which the cover portion is attached, and has a drain portion that is formed to drain water entering between the main body portion side inner wall and the main body portion side outer wall to an outside, and the cover portion has a cover portion side inner wall, a middle wall, and a cover portion side outer wall formed in the attachment direction at an end portion attached to the main body portion, and has a housing space configured to house a packing member and formed at a base end portion between the middle wall and the cover portion side inner wall, and a labyrinth structure, in which the main body portion side inner wall is inserted between the cover portion side inner wall and the middle wall and the main body portion side outer wall is inserted between the middle wall and the cover portion side outer wall in a state where the cover portion is attached to the main body portion, is formed to block water ingress between the main body portion and the cover portion by the labyrinth structure.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view of a housing box according to an embodiment;

FIG. 2 is a perspective view of the housing box according to the embodiment;

FIG. 3 is a cross-sectional view of the housing box taken along line III-III of FIG. 2;

FIG. 4 is a cross-sectional view of the housing box, and is a view illustrating a case where a packing member is not installed; and

FIG. 5 is a cross-sectional view of the housing box taken along line V-V of FIG. 2.

### DETAILED DESCRIPTION OF THE PREFERRED EMBODIMENTS

Hereinafter, an embodiment according to the present invention will be described in detail with reference to the drawings. Note that the present invention is not limited by the embodiment. In addition, constituent elements in the following embodiment include those that can be easily replaced by those skilled in the art or those that are substantially the same.

### Embodiment

The present embodiment relates to a housing box. In the following description, the first direction is referred to as a “depth direction X”, the second direction is referred to as a “width direction Y”, and the third direction is referred to as an “attachment direction Z”, the first direction, the second direction, and the third direction intersecting one another. Here, the depth direction X, the width direction Y, and the attachment direction Z are orthogonal to each other. The attachment direction Z is a direction in which a cover portion is attached to a main body portion, and corresponds to a height direction of the main body portion and the cover portion. The depth direction X and the width direction Y correspond to directions intersecting with the attachment direction Z. In addition, each direction used in the following description represents a direction in a state where the parts are assembled unless otherwise specified. The term “orthogonal” as used herein includes being substantially orthogonal.

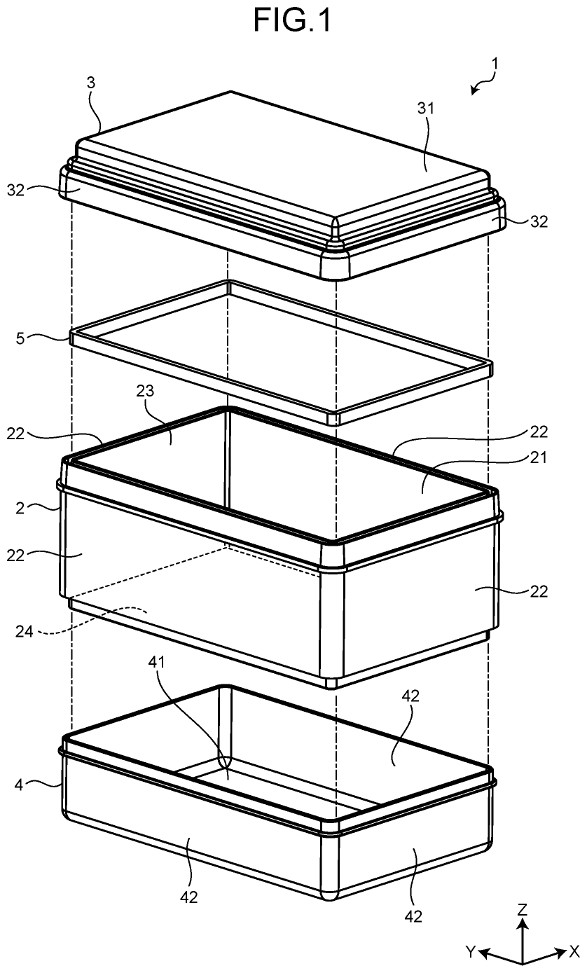

As illustrated in FIG. 1, a housing box 1 according to the present embodiment is a box that houses an object to be housed, and is used as, for example, an electrical connection box that is mounted on a vehicle and houses an electronic component including a fuse and a relay. The housing box 1 includes a main body portion 2, an upper cover 3, a lower cover 4, and a packing member 5. The main body portion 2 is a box member or a frame member whose upper surface and lower surface are open, and has, for example, a rectangular parallelepiped shape. The rectangular parallelepiped shape referred to herein includes a substantially rectangular parallelepiped shape. The main body portion 2 has, for example, four side walls 22, and is formed by arranging the side walls 22 in the attachment direction Z in which the upper cover 3 is attached and connecting the side walls 22 in the depth direction X and the width direction Y. The main body portion 2 has an internal space 21 for housing the electronic component therein.

The main body portion 2 has an opening portion 23 formed to communicate between the inside and the outside of the main body portion 2 on the upper surface, and an opening portion 24 formed to communicate between the interior and exterior on the lower surface. For example, the opening portion 23 is an opening that opens the entire upper surface of the main body portion 2, and the opening portion 24 is an opening that opens the entire lower surface of the main body portion 2. The opening portion 23 of the main body portion 2 is closed by attachment of the upper cover 3. The opening portion 24 of the main body portion 2 is closed by attachment of the lower cover 4.

The upper cover 3 is a cover portion that covers the opening portion 23 of the main body portion 2, and is attachable to and detachable from the main body portion 2. The upper cover 3 has a top surface portion 31 and a hanging portion 32. The top surface portion 31 is an upper surface portion of the upper cover 3, and has a shape conforming to the shape of the main body portion 2, for example, a rectangular shape or a substantially rectangular shape. The hanging portion 32 is a wall portion extending downward in the attachment direction Z from an outer edge of the top surface portion 31, and is formed over the entire outer edge of the top surface portion 31.

The lower cover 4 is a cover portion that covers the opening portion 24 of the main body portion 2, and is attachable to and detachable from the main body portion 2. The lower cover 4 has a bottom surface portion 41 and a side wall portion 42. The bottom surface portion 41 is a lower surface portion of the lower cover 4, and has a shape conforming to the shape of the main body portion 2, for example, a rectangular shape or a substantially rectangular shape. The side wall portion 42 is a plate-like portion extending upward in the attachment direction Z from an outer edge of the bottom surface portion 41, and is formed over the entire outer edge of the bottom surface portion 41. Although the lower cover 4 is attached on a lower side of the main body portion 2 in FIG. 1, the main body portion 2 may be formed integrally with the lower cover 4 to have a bottom portion. In addition, the housing box 1 may include a locking mechanism that locks the main body portion 2 and the upper cover 3 in an attached state, or a locking mechanism that locks the main body portion 2 and the lower cover 4 in an attached state.

The packing member 5 is a water ingress blocking member that blocks water ingress between the main body portion 2 and the upper cover 3. The packing member 5 is formed of a material having a lower rigidity than the upper cover 3, and is formed of, for example, an elastic resin such as an elastomer or an elastic member such as rubber. The packing member 5 is provided along a lower portion of the hanging portion 32 of the upper cover 3, and is formed in a rectangular ring shape that conforms to a shape of the lower portion of the hanging portion 32. The packing member 5 may be provided by, for example, two-color molding with the upper cover 3, or may be provided separately from the upper cover 3 and fitted to the upper cover 3. The packing member 5 does not have to be installed according to a water ingress blocking performance required for the housing box 1 or a specification of the housing box 1.

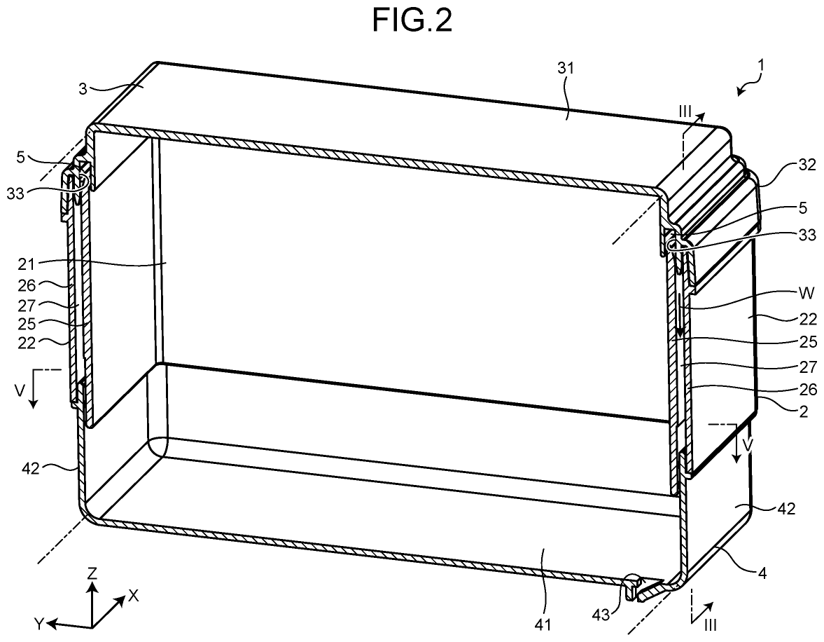

As illustrated in FIG. 2, the packing member 5 is provided on the upper cover 3, is disposed between the main body portion 2 and the upper cover 3, and blocks water ingress between the main body portion 2 and the upper cover 3. FIG. 2 is a perspective view of the housing box 1 in a state where the upper cover 3 and the lower cover 4 are attached to the main body portion 2, and illustrates the housing box 1 in a state where almost half of the housing box 1 is cut. The packing member 5 is provided, for example, in a housing space 33 formed at the lower portion of the hanging portion 32 of the upper cover 3. The housing space 33 is a groove-shaped space opened downward, and is continuously formed in the depth direction X and the width direction Y along the lower portion of the hanging portion 32.

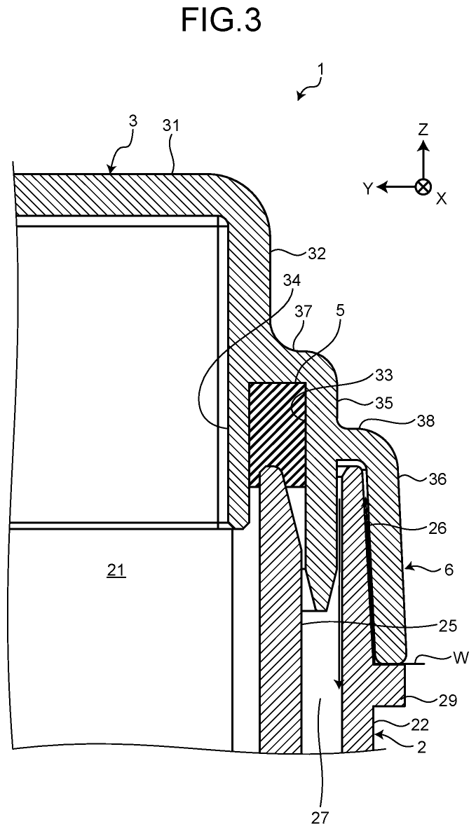

As illustrated in FIG. 3, the packing member 5 is provided and used in the housing space 33 formed in the upper cover 3. That is, in a case where the packing member 5 is installed in the housing space 33, the packing member 5 comes into contact with the main body portion 2 and the upper cover 3 to block water ingress between the main body portion 2 and the upper cover 3. FIG. 3 is an enlarged cross-sectional view of the housing box 1, illustrating a state where the upper cover 3 is attached to the main body portion 2 and a case in which the packing member 5 is provided on the upper cover 3. The upper cover 3 has an inner wall 34, a middle wall 35, and an outer wall 36 formed in the attachment direction Z at the lower portion of the hanging portion 32, and the housing space 33 capable of housing the packing member 5 is formed at a base end portion between the inner wall 34 and the middle wall 35. The middle wall 35 is spaced outward from the inner wall 34, and the outer wall 36 is spaced outward from the middle wall 35.

The inner wall 34 is a wall portion extending downward at the lower portion of the hanging portion 32, and functions as a cover portion side inner wall. The middle wall 35 is a wall portion branching outward from the inner wall 34 via a protruding portion 37. The protruding portion 37 is provided in such a way as to protrude outward from a base end portion of the inner wall 34, and the middle wall 35 extends downward from a protruding distal end of the protruding portion 37. The outer wall 36 is a wall portion branching outward from the middle wall 35 via a protruding portion 38, and functions as a cover portion side outer wall. The protruding portion 38 is provided in such a way as to protrude outward from the middle wall 35, and the outer wall 36 extends downward from a protruding distal end of the protruding portion 38. A lower end of the outer wall 36 comes into contact with a protrusion 29 formed on the side wall 22, and is supported by the protrusion 29. The protrusion 29 is a portion protruding from the side wall 22, and extends continuously in the depth direction X and the width direction Y, for example.

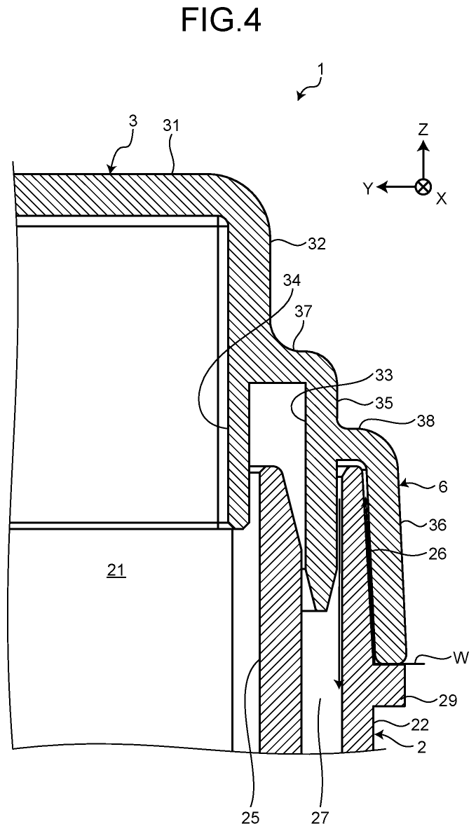

As illustrated in FIG. 4, the housing space 33 is formed at the base end portion between the inner wall 34 and the middle wall 35. FIG. 4 is an enlarged cross-sectional view of the housing box 1, illustrating a state where the upper cover 3 is attached to the main body portion 2 and a case where the packing member 5 is not provided on the upper cover 3. The housing space 33 is a space capable of housing the packing member 5 and has a larger width in the width direction Y and a larger height in the attachment direction Z larger as compared with a thickness of the hanging portion 32, for example. In addition, the housing space 33 has a larger width in the width direction Y and a larger height in the attachment direction Z as compared with a thickness of an inner wall 25, for example. In a case where the packing member 5 is not installed, the housing space 33 forms a cavity between the main body portion 2 and the upper cover 3 in a state where the upper cover 3 is attached to the main body portion 2. The side wall 22 of the main body portion 2 has the inner wall 25 and an outer wall 26. For example, the side wall 22 has an inner-outer dual-wall structure including the inner wall 25 and the outer wall 26, and the inner wall 25 and the outer wall 26 are spaced apart from each other. The inner wall 25 is a wall portion formed in the attachment direction Z, and functions as a main body portion side inner wall. The outer wall 26 is a wall portion formed in the attachment direction Z, and functions as a main body portion side outer wall.

The main body portion 2 and the upper cover 3 form a labyrinth structure 6 in a state where the upper cover 3 is attached to the main body portion 2. That is, the inner wall 25 of the main body portion 2 is inserted between the inner wall 34 and the middle wall 35 of the upper cover 3, and the outer wall 26 is inserted between the middle wall 35 and the outer wall 36. As a result, the labyrinth structure 6 in which an entry path of water W is folded back in an upward direction and a downward direction is formed. For example, in a case where the water W enters from between the outer wall 36 and the outer wall 26, the water W cannot enter the internal space 21 at an upper portion of the housing box 1 unless the water W passes through a path directed upward between the outer wall 36 and the outer wall 26, a path directed downward between the outer wall 26 and the middle wall 35, a path directed upward between the middle wall 35 and the inner wall 25, and a path directed downward between the inner wall 25 and the inner wall 34. Therefore, the water W is prevented from entering the internal space 21 through between the upper cover 3 and the main body portion 2.

In the main body portion 2, a drain portion 27 for draining water W entering between the outer wall 26 and the inner wall 25 to the outside is formed. The drain portion 27 is a drain passage formed between the outer wall 26 and the inner wall 25, and is formed from an upper portion to a lower portion of the side wall 22. As illustrated in FIG. 2, even when the water W reaches between the outer wall 26 and the inner wall 25 from the outside, the water W is drained to the outside of the housing box 1 through the drain portion 27. For example, the water W flowing downward in the drain portion 27 is drained to the outside from between the side wall portion 42 and the outer wall 26, or falls onto the bottom surface portion 41 of the lower cover 4 and is drained to the outside from a drain port 43 formed in the bottom surface portion 41.

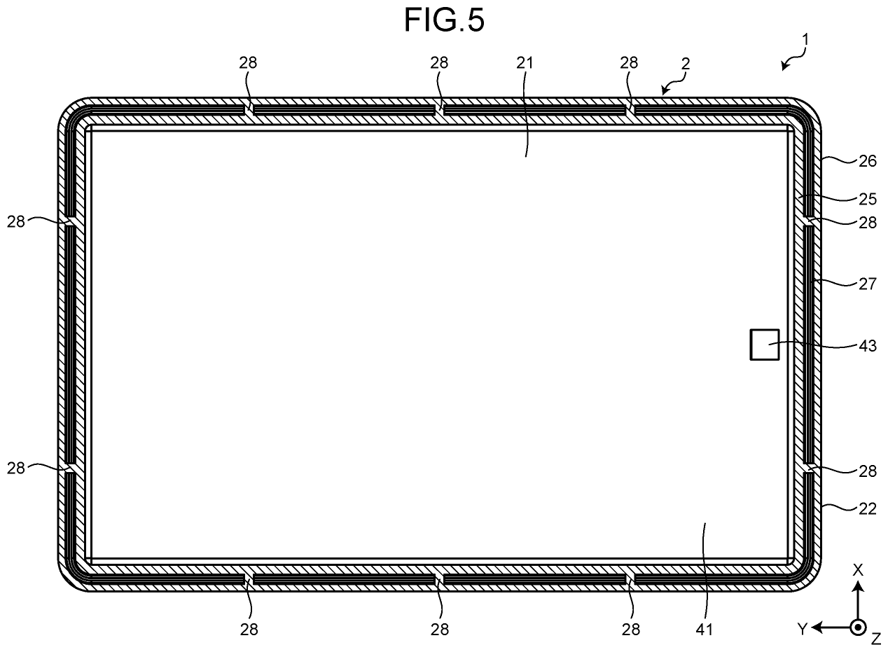

As illustrated in FIG. 5, the inner wall 25 and the outer wall 26 are connected and supported by a plurality of ribs 28 at predetermined intervals in the depth direction X and the width direction Y. A region where the rib 28 is not formed between the inner wall 25 and the outer wall 26 functions as the drain portion 27.

Next, adjustment of the water ingress blocking performance of the housing box 1 according to the present embodiment will be described.

The water ingress blocking performance of the housing box 1 can be adjusted depending on whether or not the packing member 5 is installed. In a case where the packing member 5 is not installed in the housing space 33 as illustrated in FIG. 4, water ingress between the main body portion 2 and the upper cover 3 is blocked by the labyrinth structure 6 of the main body portion 2 and the upper cover 3. For example, in a case where the water W enters from between the outer wall 36 and the outer wall 26, the water W needs to enter through a gap formed by folding back of the labyrinth structure 6 in the vertical direction, as a result of which the water W does not easily enter. Therefore, a predetermined water ingress blocking performance is exhibited. Further, even in a case where the water W enters beyond the outer wall 26, the water W falls downward by the drain portion 27. Therefore, it is very difficult for the water W to reach the internal space 21 beyond the inner wall 25. As described above, in the housing box 1, even in a case where the packing member 5 is not installed, a predetermined water ingress blocking performance can be secured, and thus, cost reduction can be achieved by reducing the number of parts. Although the water W may fall from the drain portion 27 onto the bottom surface portion 41 of the lower cover 4, in a case where the upper portion or middle portion of the internal space 21 in the housing box 1 is a region where water ingress is to be blocked, there is no problem in a water ingress blocking function of the housing box 1.

As illustrated in FIG. 3, in a case where the packing member 5 is installed in the housing space 33, water ingress between the main body portion 2 and the upper cover 3 is blocked by installing the labyrinth structure 6 of the main body portion 2 and the upper cover 3, and the packing member 5. In this case, the housing box 1 can exhibit a higher water ingress blocking performance as compared with a case where the packing member 5 is not installed in the housing space 33. For example, in a case where the water W enters from between the outer wall 36 and the outer wall 26, the water W needs to enter through a gap formed by folding back of the labyrinth structure 6 in the vertical direction, as a result of which the water W does not easily enter. Further, even in a case where the water W enters beyond the outer wall 26, the water W falls downward by the drain portion 27. Therefore, it is very difficult for the water W to reach the internal space 21 beyond the inner wall 25. Further, the packing member 5 is installed in the housing space 33, and the inner wall 25 abuts on the packing member 5 from below. Therefore, the water W is prevented from entering the internal space 21 beyond the inner wall 25. For example, it is conceivable that the water W flows backward through the drain portion 27 and rises in a case where the water W is jetted by applying a water pressure from below the housing box 1. However, as the packing member 5 in the housing space 33 is installed, the water W is prevented from entering the internal space 21 beyond the inner wall 25.

As described above, the housing box 1 according to the present embodiment can be used with different water ingress blocking performances while using the same structures as the main body portion 2 and the upper cover 3. Therefore, even in a case where different water ingress blocking performances are required for the housing box 1 due to different installation environments, specifications, or the like, it is possible to provide the housing box 1 having a water ingress blocking performance matching a requirement by installing or not installing the packing member 5 without changing designs of the main body portion 2 and the upper cover 3.

As described above, in the housing box 1 according to the present embodiment, the housing space 33 of the packing member 5, the labyrinth structure 6, and the drain portion 27 are formed in the main body portion 2 and the upper cover 3, so that the water ingress blocking performance can be adjusted according to the required water ingress blocking performance.

In addition, in the housing box 1 according to the present embodiment, the water ingress blocking performance between the main body portion 2 and the upper cover 3 can be adjusted by setting whether or not to install the packing member 5 in the housing space 33. Therefore, the housing box 1 can have the water ingress blocking performance according to the required water ingress blocking performance, specifications, or the like.

In addition, in the housing box 1 according to the present embodiment, the water ingress blocking performance between the main body portion 2 and the upper cover 3 can be enhanced by installing the packing member 5 in the housing space 33.

In addition, in the housing box 1 according to the present embodiment, as the packing member 5 is not installed in the housing space 33, the housing space 33 forms a cavity. Therefore, it is possible to reduce the manufacturing cost while securing a predetermined water ingress blocking performance by the labyrinth structure 6 and the drain portion 27.

In addition, in a case where the housing box 1 according to the present embodiment is used as an electrical connection box that is mounted on a vehicle and houses an electronic component, it is possible to adjust the water ingress blocking performance to an appropriate water ingress blocking performance according to the required water ingress blocking performance.

Although the housing box 1 according to the embodiment has been described above, the housing box according to the present invention is not limited to the above-described embodiment, and various modifications can be made within the scope described in the claims. In addition, the housing box 1 according to the present embodiment may be configured by appropriately combining the constituent elements of the above-described embodiment and the modifications.

For example, although the housing box 1 in which two wall portions of the inner wall 25 and the outer wall 26 of the main body portion 2 are inserted into three wall portions of the inner wall 34, the middle wall 35, and the outer wall 36 of the upper cover 3 to form the labyrinth structure 6 has been described in the above-described embodiment, the labyrinth structure may be formed by inserting three or more wall portions of the main body portion 2 into four or more wall portions of the upper cover 3. Similarly to the housing box 1 according to the above-described embodiment, the water ingress blocking performance of such a housing box can also be adjusted according to the required water ingress blocking performance.

In addition, although an electrical connection box that is mounted on a vehicle and houses an electronic component is applied as the housing box 1 has been described in the above-described embodiment, but the housing box according to the present invention may be applied to a housing box that is not mounted on a vehicle. In addition, the housing box according to the present invention may be applied to a housing box that houses an object to be housed other than an electronic component.

In the housing box of the present embodiment, the water ingress blocking performance can be adjusted.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A housing box comprising:
a main body portion that is configured to house an object to be housed in the main body portion and has an opening portion formed to communicate between an inside and an outside of the main body portion; and
a cover portion that is attached to the main body portion in such a way as to cover the opening portion,
wherein the main body portion has a main body portion side inner wall and a main body portion side outer wall formed in an attachment direction of the cover portion at an end portion to which the cover portion is attached, and has a drain portion that is formed to drain water entering between the main body portion side inner wall and the main body portion side outer wall to an outside, and
the cover portion has a cover portion side inner wall, a middle wall, and a cover portion side outer wall formed in the attachment direction at an end portion attached to the main body portion, and has a housing space configured to house a packing member and formed at a base end portion between the middle wall and the cover portion side inner wall, and
a labyrinth structure, in which the main body portion side inner wall is inserted between the cover portion side inner wall and the middle wall and the main body portion side outer wall is inserted between the middle wall and the cover portion side outer wall in a state where the cover portion is attached to the main body portion, is formed to block water ingress between the main body portion and the cover portion by the labyrinth structure.

2. The housing box according to claim 1, wherein
a water ingress blocking performance between the main body portion and the cover portion is adjustable by installing or not installing the packing member in the housing space.

3. The housing box according to claim 1, further comprising:
the packing member that is installed in the housing space and comes into contact with the main body portion and the cover portion to block water ingress between the main body portion and the cover portion.

4. The housing box according to claim 2, further comprising:
the packing member that is installed in the housing space and comes into contact with the main body portion and the cover portion to block water ingress between the main body portion and the cover portion.

5. The housing box according to claim 1, wherein
the housing space forms a cavity between the main body portion and the cover portion in a state where the cover portion is attached to the main body portion.

6. The housing box according to claim 2, wherein
the housing space forms a cavity between the main body portion and the cover portion in a state where the cover portion is attached to the main body portion.

7. The housing box according to claim 1, wherein
the housing box is an electrical connection box that is mounted on a vehicle and houses an electronic component as the object to be housed.

8. The housing box according to claim 2, wherein
the housing box is an electrical connection box that is mounted on a vehicle and houses an electronic component as the object to be housed.
